(19) United States
(12) Patent Application Publication
(10) Pub. No.: US 2010/0104828 A1
(43) Pub. Date: Apr. 29, 2010

(54) Moulded Skin and Method for Production Thereof

(76) Inventors: Jürgen Engel, Bitzen/Dunebusch (DE); Norbert Bonhoff, Borken (DE); Rob Chimelak, Warren, MI (US); Godefroy Beau, La Garenne Colombes (FR)

Correspondence Address: FAY KAPLUN & MARCIN, LLP, 150 BROADWAY, SUITE 702, NEW YORK, NY, 10038, US

(21) Appl. No.: 12/582,314

(22) Filed: Oct. 20, 2009

Related U.S. Application Data
(60) Provisional application No. 61/108,244, filed on Oct. 24, 2008.

(51) Int. Cl. B44C 1/26; B44C 5/04; B29C 45/14; B29C 70/84

(52) U.S. Cl. 428/195.1; 264/271.1; 264/46.4; 156/245

(57) ABSTRACT

A method is for production of a moulded skin. The method includes a) inserting a film into a clamping frame; b) moving a positive mould relative to the clamping frame for pre-shaping of the film; c) impressing an insert on a side of the film which is orientated away from the positive mould; d) moving the positive mould into a negative mould which corresponds at least in regions; and e) applying a low pressure from the negative mould in order to emboss at least one of a shape and a surface structure of the negative mould onto the film fitted with the insert.

### PRIORITY CLAIM

This application claims priority to U.S. Provisional Patent Appln. Ser. No. 61/108,244 filed on Oct. 24, 2008 and which is expressly incorporated herein, in its entirety, by reference.

### FIELD OF INVENTION

The present invention relates to a moulded skin and also to a method for production thereof. The moulded skin is suitable in particular for interior trim parts of automotive vehicles.

### BACKGROUND INFORMATION

It is known to draw heated plastic material films into a negative mould by means of low pressure, in order that the film adopts the shape or also the surface impression of the negative mould. Such a method is known as “In Mould Graining” (IMG).

Backfoaming of the moulded skin is possible subsequently or lamination on a carrier in order thus to obtain a finished interior trim part for automotive vehicles, for instance an instrument panel.

In particular for more exclusive models of a construction series of vehicles, a requirement exists to integrate high-quality applications (for example made of wood or metal) into the interior trim part. The edge spacing of the insert relative to the surrounding moulded skin should hereby be relatively small (freedom from gaps) in order to ensure an attractive exterior.

It is possible for example to apply incisions in the moulded skin and to insert the inserts manually. However this is very cost-intensive.

Another possibility resides in jointly introducing inserts during the production process of the moulded skin. However, precise placing of the insert with respect to the remaining moulded skin and also careful treatment of the insert (for example in order to avoid undesired embossing of the surface structure of the negative moulding tool on the insert) is relevant here.

### SUMMARY OF INVENTION

The present invention relates a method for the production of a moulded skin or a moulded skin in which, at low cost, an insert with a high-quality appearance can be fitted in a precise fit into a moulded skin.

In the case of the method according to the invention for the production of a moulded skin, the following steps are implemented:
a) Inserting a film into a clamping frame,
b) Moving a positive mould relative to the clamping frame (the positive mould configured as die is preferably moveable upwards (+Z) and downwards (−Z) for (pre-)shaping of the film,
Impressing an insert on the side of the film which is orientated away from the positive mould,
d) Moving the positive mould into a negative mould which corresponds at least in regions and
e) Applying low pressure from the negative mould in order to emboss the shape and/or surface structure of the negative mould onto the film fitted with the insert.

Moving the clamping frame against a positive mould for (pre-)shaping of the film hereby ensures that a relatively uniform pre-stretching of the film is effected. This can be combined particularly well with impressing an insert. The positive mould forms an abutment here for the insert. This is doubly advantageous since the positive mould (which can also have for example vacuum openings for drawing on/positioning the film) forms a mechanically strong abutment and it is ensured by the prescribed shape that, during the subsequent vacuum moulding process in the negative moulding tool, no distortion or displacement of the insert is effected as a result of non-uniform stretching.

Only thereafter does moving the positive mould into the negative mould which corresponds at least in regions take place. Subsequently, by applying low pressure from the negative mould in order to emboss the shape and/or surface structure of the negative mould, the moulded skin is produced. The preferably greatly heated film is hereby correspondingly reshaped or a desired surface structure is applied. In particular because of the pre-shaping by means of the positive mould, an essentially uniform thickness of the film is achieved here. In addition, during the vacuum moulding on the negative mould, it is achieved that the insert is fitted flush with the surface and essentially without a gap into the remaining moulded skin, as a result of which the qualitative appearance of the moulded skin is increased greatly.

In addition, it is an advantage of the method that no changes require to be undertaken on the positive or negative mould for fitting in the insert, consequently no increased tool costs occur and the “base to premium” desired by automotive vehicle producers is possible with a single tool.

The moulded skin according to the invention represents a three-dimensionally shaped film for covering an interior trim part for automotive vehicles, the insert being introduced in the manner described above on the side which is disposed towards an automotive vehicle interior.

An advantageous development of the method resides in the fact that the moulded skin is subsequently backfoamed, backinjected or backembossed (or back-injection-moulded) and/or is provided with a carrier. Hence normal methods for achieving a “soft-touch” effect or for laminating with the moulded skin according to the invention are possible.

A further development provides that the positive mould contacts a smaller surface region of the film than the negative mould. In principle, the positive mould can enclose the same or even a large surface region of the film than the negative mould. Normally, this surface region will to some extent be equal in order to achieve the above-described pre-shaping of the film by the positive mould. In the case of films with very good stretching behaviour, in which therefore a uniform wall thickness can be achieved even in the negative vacuum moulding tool without pre-stretching, the positive mould can however also represent a significantly smaller percentage region of the contacting surfaces. In principle, it suffices here if the positive mould represents an “abutment” to the die which applies the insert on the other side of the film. Otherwise, the positive mould can turn out to be somewhat larger, for example in order to achieve pre-shaping in the region of particularly severe topographical jumps.

A small area of the positive mould (for example between 1 and 5% of the contact surface relative to the surface between negative mould and film) is in principle possible if merely impressing the insert is involved. In the case of reshaping processes in which, in addition to the vacuum moulding in the negative mould, also a “pressing component” is contained in which therefore reshaping (additionally) is achieved between positive mould and negative mould by pressing, greater overlaps and also dispensing with a residual gap between negative mould and positive mould are sensible in the final state.

A further advantageous development provides that impressing the insert is implemented by a die which is introduced laterally into the tool containing the clamping frame. As a result, it is made possible that a corresponding die can be easily retrofitted to an existing moulding tool. In the case of moulding tools which provide merely a clamping frame and a negative mould, the positive mould can also be introduced laterally, in particular when the latter is intended to come into contact only with a very small surface region of the film in order there to fulfil the function of the die abutment.

A further advantageous development provides that the film, before contact with the positive mould, has a temperature between 160° C. and 250° C., preferably between 210° and 220° C., the material of the film is hereby preferably single-layer TPO material (TPO=thermoplastic olefin). However any other plastic material films which are suitable for use in negative vacuum reshaping are applied here.

The material choice with the insert is relatively open, this can be made from plastic material, metal, wood or similar materials. High temperature stability is advantageous with inserts.

A particularly advantageous development provides that the insert is two-layer, the top layer of the insert, before completing the moulded skin or of the interior trim part, being able to be withdrawn from a remaining insert in order to achieve a circumferential and defined depression of the remaining insert relative to the adjacent portion of the moulded skin.

As a result, a very high-quality appearance is produced on the one hand. In addition, it is achieved that the insert is not impaired by a specific surface structure of the negative vacuum moulding tool. Finally, it is advantageous that slight deviations in the depth offset are not perceived so greatly by the eye of the observer as in the case of remaining inserts which are flush with the surface. In the case of the moulded skin according to the invention, the depth offset between the insert and the portion of the moulded skin surrounding the insert should be between 1 and 10 mm, the variations in depth offset in one pass of the visible-side edge contour of the insert preferably being less than 1 mm.

The gap in the surface plane of the moulded skin relative to the insert should also be as small as possible, at most 1 mm, preferably at most 0.5 mm, for particular preference not exceeding 0.1 mm. From a production point of view it is however hereby favourable that, with a depth offset of the remaining insert, a gap which is offset backwards is less visible because of the limited light incidence than in the case of arrangements which are flush with the surface.

A further advantageous development provides that the (remaining) insert is offset backwards relative to the surrounding moulded skin and the radius of curvature of the edge of the moulded skin around the insert is less than 3 mm, preferably less than 1 mm. Such small radii of curvature are simple from a production technology point of view and can be manufactured nevertheless with the best quality since, because of the removeable top layer of the insert, a corresponding specification of the edge structure due to the top layer edge structure of the insert is possible and hence (without high tool costs) the edge structure of the moulded skin around the remaining insert can be adjusted well in any way. In addition, it is important here that, by referencing the top layer with respect to the remaining insert, the tolerances appear significantly more favourable than with a specification of the edge structure of the moulded skin by the negative moulding tool in which the spatial relationship to the insert would be tolerance-related.

A further advantageous embodiment provides that the insert is configured as a retainer which is replaced before completion of the moulded skin by a final insert which remains in the moulded skin. As a result, the greatest possible care of the insert during the production process is achieved (for example with inserts which are flush with the surface). In addition, this method is favourable with inserts which react negatively to a high temperature of the film.

### BRIEF DESCRIPTION OF DRAWINGS

The present invention is now explained with reference to several Figures. There are shown:

FIG. 1a a negative mould, a positive mould and also a clamping frame holding a film at the beginning of the method according to an exemplary embodiment of the present invention,

FIG. 1b a film shaped by the positive mould before impressing the insert,

FIG. 1c the moulded skin produced in the negative mould by low pressure with inserted two-layer insert,

FIG. 2a a finished interior trim part with remaining insert, and

FIG. 2b a detailed view of the region around the remaining insert of FIG. 2a.

### DETAILED DESCRIPTION

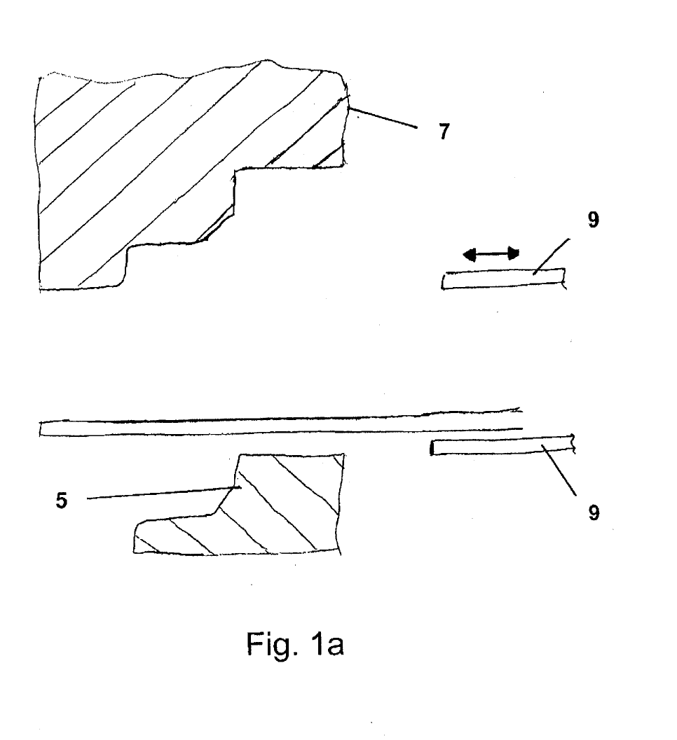

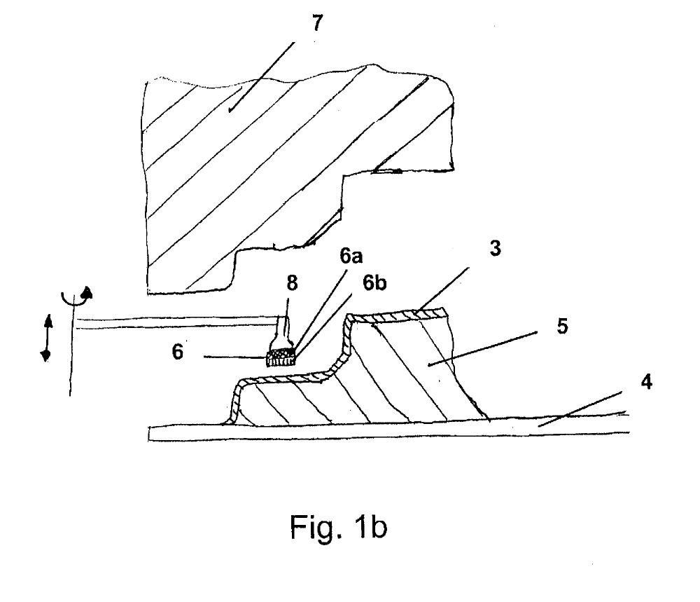

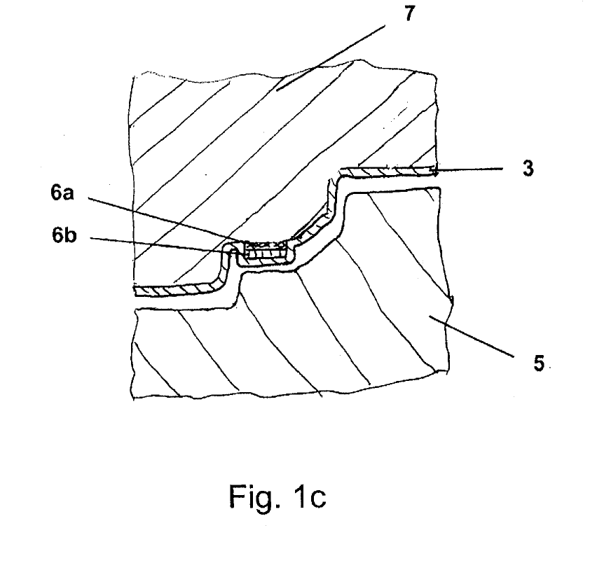

FIG. 1a shows a tool for implementing the method according to the invention. Shown here is a positive mould 5, thereabove a clamping frame 4 which holds a film 3 in a clamped position. A negative mould 7 is disposed above the clamping frame and has vacuum openings which are not shown in more detail in the Figures (these can be produced for example as porous surfaces of the negative mould). Two plate-shaped heating elements 9, as indicated with a double arrow above the upper heating plate 9, can be displaced over the clamping frame or the film in order hence to heat the film to a temperature between 160° C. and 250° C., preferably between 210° C. and 220° C.

The positive mould can be provided in addition with vacuum openings, not represented here, for suctioning and fixing the film 3.

After heating the film 3 and withdrawing the plate-shaped heating element 9 into the position shown in FIG. 1a, the positive mould 5 moves against the film so that the pattern shown in FIG. 1b is produced. In this position, the film 3 is pre-shaped, the film assumes essentially the shape of the positive mould 5, this is essentially corresponding to the shape of the negative mould 7. In this position, the positive mould 5 pauses and a two-layer insert 6 is pressed onto the film 3 by means of a die 8. The insert comprises a top layer 6a and also a remaining insert 6b, the underside of the remaining insert shown in FIG. 1b being provided with a heat-activatable adhesive which has adhesive properties from approx. 40° C. This is bonded to the film with a heat of approx. 210° C., said film is configured from a thermoplastic olefin and is one-layered. The insert 6 comprises a top layer 6a comprising plastic material and a piece 6b comprising wood. The die 8 is pivoted for example by means of a pivoting mechanism (see pivoting direction about the vertical axis in FIG. 1b) between the positive mould 5 and the negative mould 7 so that the die can be applied above the intended positioning point of the insert 6 on the film 3. Impressing is effected via a stroke movement as illustrated in FIG. 1b, indicated on the left by a double arrow. Alternatively thereto, an upwards movement of the positive mould 5 can also be effected. In the present case, the contact surface of the positive mould 5 with the film 3 is precisely as large as the contact surface of the negative mould 7 with the film 3. After pivoting the die 8 out of the intermediate space between positive mould 5 and negative mould 7, a strong low pressure is applied to the vacuum openings of the negative mould 7 so that the film 3 is suctioned towards the negative mould 7 around the two-layer insert 6. The state shown in FIG. 1c is produced. According to the configuration of the movement, “subsequent pressing” can be effected by means of the positive mould 5, a recess for the region curved out by the insert possibly requiring to be provided here in the positive mould 5.

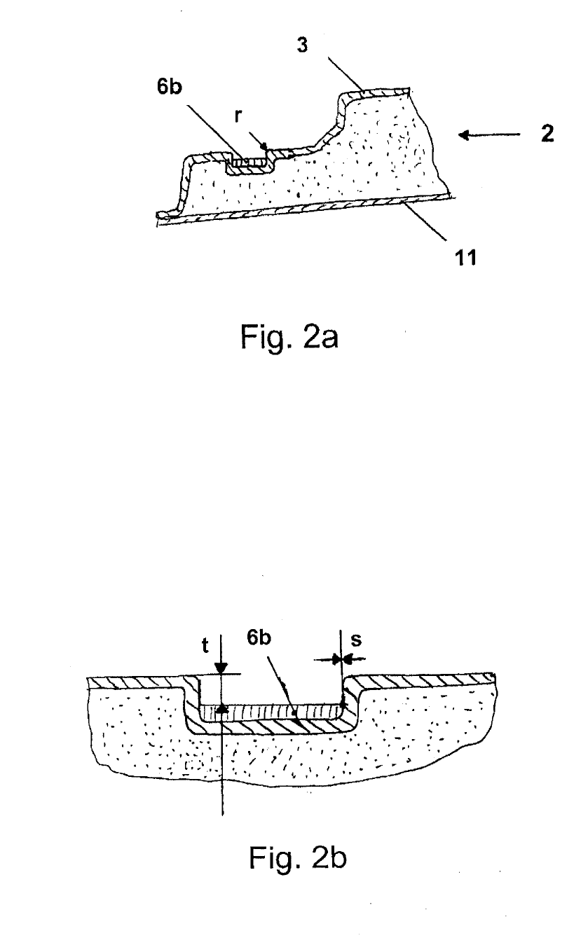

After removal and cooling the now finished moulded skin in which possibly also another surface structure of the negative mould 7 has been embossed on the film or moulded skin, the latter is removed from the tool or backfoamed, backinjected or backembossed also in the same tool and also provided with a carrier 11. After withdrawing the top layer 6a, the state shown in FIG. 2a is produced, which shows a finished interior trim part 2.

In an alternative variant of the method, the insert can also be chosen to be one-part or an insert can also be inserted as “retainer” which is replaced, before completion of the moulded skin, by a final insert which remains in the moulded skin.

An important aspect of the invention resides in the fact that the insert 6 or remaining insert 6b is fitted into the remaining moulded skin with a high-quality appearance. It is hereby advantageous that the gap s (see FIG. 2b) is as small as possible, presently below 0.1 mm. Even with a small remaining gap, this is however not annoying since, in FIG. 2b, the remaining insert 6b is set backwards relative to the surrounding moulded skin by the depth offset t, this depth offset is presently 5 mm. Variations in the depth offset are presently less than 1 mm.

The radius of curvature r (see FIG. 2a) can in addition be adjusted in any manner, at present it is less than 3 mm. The curvature can hereby be prescribed by a corresponding shaping of the top layer 6a of the insert 6, a corresponding edge contour can be provided here on the side of the top layer 6a which is orientated towards the negative mould 7 and with which practically any edge geometries of the moulded skin can be produced here.

### REFERENCE NUMBER LIST

1 Moulded skin
2 Interior trim part
3 Film
4 Clamping frame
5 Positive mould
6 Inserts:
   6a Top layer;
   6b Remaining insert
7 Negative mould
8 Die
9 Heating element
r Radius of curvature
s Gap
t Depth offset

What is claimed is:

1. A method for production of a moulded skin, comprising:
a) inserting a film into a clamping frame;
b) moving a positive mould relative to the clamping frame for pre-shaping of the film;
c) impressing an insert on a side of the film which is orientated away from the positive mould;
d) moving the positive mould into a negative mould which corresponds at least in regions; and
e) applying a low pressure from the negative mould in order to emboss at least one of a shape and a surface structure of the negative mould onto the film fitted with the insert.

2. The method according to claim 1, wherein the moulded skin includes an interior trim part of an automotive vehicle.

3. The method according to claim 1, further comprising:
subsequently one of backfoamed, backinjected and backembossed the moulded skin in order to produce an interior trim part.

4. The method according to claim 1, wherein the positive mould contacts a smaller surface region of the film than the negative mould.

5. The method according to claim 1, wherein a first of a positive mould which is brought in contact with the film is between 1 and 100% of a second surface of the negative mould which is brought in contact with the film.

6. The method according to claim 1, wherein a first of a positive mould which is brought in contact with the film is between 1 and 5% of a second surface of the negative mould which is brought in contact with the film.

7. The method according to claim 1, wherein a first of a positive mould which is brought in contact with the film is between 90 and 100% of a second surface of the negative mould which is brought in contact with the film.

8. The method according to claim 1, wherein impressing the insert is implemented by a die which is introduced laterally into a tool containing the clamping frame.

9. The method according to claim 1, wherein the film, before contact with the positive mould, has a temperature between 160 and 250° C.

10. The method according to claim 1, wherein the film, before contact with the positive mould, has a temperature between 210 and 220° C.

11. The method according to claim 1, wherein a material of the film is a TPO material (TPO=thermoplastic olefin).

12. The method according to according claim 1, wherein a material of the insert is one of plastic material, metal and wood.

13. The method according to claim 1, wherein the insert includes a top layer and a bottom layer, the top layer, before completion of the moulded skin, being able to be withdrawn from a remaining insert in order to achieve a circumferential defined depression of the remaining insert relative to the adjacent portion of the moulded skin.

14. The method according to claim 12, wherein the insert includes a top layer and a bottom layer, the top layer, before completion of the interior trim part, being able to be withdrawn from a remaining insert in order to achieve a circumferential defined depression of the remaining insert relative to the adjacent portion of the moulded skin.

15. The method according to claim 1, wherein the insert is configured as a retainer which is replaced before completion of the moulded skin by a final insert which remains in the moulded skin.

16. The method according to claim 1, wherein at least one of the insert and the portion of the film to be brought in contact herewith are provided with a heat-activatable adhesive before impressing in order to join the insert and the film.

17. A moulded skin, comprising:
a three-dimensionally shaped film covering an interior trim part for an automotive vehicle; and
an insert applied to the film on a side which is orientated towards an interior of the automotive vehicle.

18. The moulded skin according to claim 17, wherein the insert is set backwards relative to the surrounding moulded skin, a radius of curvature of an edge of the moulded skin around the insert being less than 3 mm.

19. The moulded skin according to claim 17, wherein the insert is set backwards relative to the surrounding moulded skin, a radius of curvature of an edge of the moulded skin around the insert being less than 1 mm.

20. The moulded skin according to claim 17, wherein a gap in a surface plane of the moulded skin is at most 1 mm.

21. The moulded skin according to claim 17, wherein a gap in a surface plane of the moulded skin is at most 0.5 mm.

22. The moulded skin according to claim 17, wherein a gap in a surface plane of the moulded skin is at most 0.1 mm.

23. The moulded skin according to claim 17, wherein a depth offset between the insert and a portion of the moulded skin surrounding the insert is between 1 mm and 10 mm, variations in depth offset in one pass of a visible-side edge contour of the insert being less than 1 mm.
